(19) United States
(12) Patent Application Publication
(10) Pub. No.: US 2026/0181508 A1
(43) Pub. Date: Jun. 25, 2026

(54) RADIO LINK FAILURE (RLF) DETECTION FOR LOWER LAYER TRIGGERED MOBILITY

(71) Applicant: Nokia Technologies Oy, Espoo (FI)

(72) Inventors: Halit Murat GÜRSU, Munich (DE); Lars DALSGAARD, Oulu (FI); Tero HENTTONEN, Espoo (FI); Faranaz SABOURI-SICHANI, Aalborg (DK); Timo KOSKELA, Oulu (FI); Chitradeep MAJUMDAR, Bangalore (IN)

(73) Assignee: Nokia Technologies Oy, Espoo (FI)

(21) Appl. No.: 19/423,208

(22) Filed: Dec. 17, 2025

(30) Foreign Application Priority Data
Dec. 21, 2024 (IN) 202441101616

(51) Int. Cl. H04W 36/30; H04W 36/00

(52) U.S. Cl. CPC H04W 36/305; H04W 36/0077

(57) ABSTRACT

In some example embodiments, there may be provided a method, comprising receiving at least one Lower Layer Triggered Mobility (LTM) configuration message from a network node, which includes at least one timer configuration for monitoring of an ongoing or imminent Radio Link Failure (RLF), monitoring at least one beam from the network node based on the at least one timer configuration.

### FIELD

Various example embodiments relate to the field of wireless communication and, in particular to Lower Layer Triggered Mobility (LTM) and/or Radio Link Failure (RLF) detection for LTM.

### BACKGROUND

In the field of wireless communication, Lower Layer Triggered Mobility (LTM) or Layer 1 (L1)/Layer 2 (L2) Triggered Mobility may relate to a mobility management concept in cellular networks, which may include a cell switch process, where an apparatus', e.g. a User Equipment's (UE), serving cell may be switched, e.g. to a candidate cell or target cell. This may include the apparatus, e.g. the UE, performing and/or reporting measurements on target cells, which may be configured by the network. It may be beneficial, e.g. among others, to reduce and/or minimize data interruption during a cell switch process, e.g. caused and/or influenced by Radio Link Failures (RLF). LTM procedures may rely on specific indicators, operations and/or parameters that affect, complicate and/or impair utilization of existing techniques or procedures. For example, it may be the case that existing solutions or mechanisms are neither suitable for nor compatible with LTM measurements and/or LTM procedures. It may be beneficial to provide and/or improve RLF detection for TLM procedures, e.g. to improve mobility management and/or to reduce interruptions, e.g. at least partially.

### SUMMARY

According to some aspects, there is provided the subject matter of the independent claims. Some further aspects, advantages and/or features are defined in the dependent claims, the description and/or the accompanying drawings.

In a first example aspect, there may be provided an apparatus, comprising:
at least one processor; and
at least one memory storing instructions that, when executed by the at least one processor, cause the apparatus at least to perform:
receiving at least one Lower Layer Triggered Mobility (LTM) configuration message from a network node, which includes at least one timer configuration for monitoring of an ongoing or imminent Radio Link Failure (RLF),
monitoring at least one beam from the network node based on the at least one timer configuration.

In an example embodiment, there is provided an apparatus, in particular according to the first example aspect described herein, wherein the at least one timer configuration includes at least one timer indicative of a time period for monitoring the ongoing or imminent RLF.

In an example embodiment, there is provided an apparatus, in particular according to the first example aspect and/or any one of the associated example embodiments described herein, wherein the at least one timer configuration includes at least one condition that specifies when ongoing or imminent RLF is to be declared or when at least one timer associated with the at least one timer configuration is to be started.

In an example embodiment, which may be referred to as a first example embodiment of the first example aspect, there is provided an apparatus, in particular according to the first example aspect and/or any one of the associated example embodiments described herein, wherein the at least one timer configuration includes at least one indication that indicates a usage requirement of the at least one timer configuration.

In an example embodiment, which may be referred to as a second example embodiment of the first example aspect, there is provided an apparatus, in particular according to the first example aspect and/or any one of the associated example embodiments described herein, wherein the at least one indication indicates for which events the at least one timer configuration is to be applied.

In an example embodiment, there is provided an apparatus, in particular according to the first example aspect and/or any one of the first example embodiment of the first example aspect and/or the second example embodiment of the first example aspect described herein, wherein the at least one indication indicates at least a first beam of a target cell and at least a second beam of a serving cell for which the at least one timer configuration is to be used.

In an example embodiment, there is provided an apparatus, in particular according to the first example aspect and/or any one of the first example embodiment of the first example aspect and/or the second example embodiment of the first example aspect described herein, wherein the at least one indication indicates at least a requirement for transmission of at least one Layer 1 measurement report to the network node

In an example embodiment, which may be referred to as a third example embodiment of the first example aspect, there is provided an apparatus, in particular according to the first example aspect and/or any one of the first example embodiment of the first example aspect and/or the second example embodiment of the first example aspect described herein, wherein the at least one indication indicates that the at least one timer configuration is to be applied based on at least one LTM reporting event.

In an example embodiment, there is provided an apparatus, in particular according to the first example aspect and/or the third example embodiment of the first example aspect described herein, wherein the at least one LTM reporting event is a LTM3 reporting event for which a signal strength of a beam from a target cell of the network node is compared to a signal strength of a beam from a serving cell of the network node.

In an example embodiment, there is provided an apparatus, in particular according to the first example aspect and/or the third example embodiment of the first example aspect described herein, wherein the at least one LTM reporting event is a LTM4 reporting event for which a signal strength of a beam from a target cell of the network node is compared to a predefined threshold.

In an example embodiment, there is provided an apparatus, in particular according to the first example aspect and/or any one of the first example embodiment of the first example aspect and/or the second example embodiment of the first example aspect described herein, wherein the at least one indication indicates that the at least one timer configuration is to be applied based on initiation of early Timing Advance (TA) acquisition.

In an example embodiment, there is provided an apparatus, in particular according to the first example aspect and/or any one of the first example embodiment of the first example aspect and/or the second example embodiment of the first example aspect described herein, wherein the at least one indication indicates that the at least one timer configuration is to be applied based on at least one of:
reception of a Target Cell Identity (TCI) state activation command, or
activation of TCI state.

In an example embodiment, there is provided an apparatus, in particular according to the first example aspect and/or any one of the first example embodiment of the first example aspect and/or the second example embodiment of the first example aspect described herein, wherein the at least one indication indicates that the at least one timer configuration is to be applied based on a User Equipment (UE)-TA estimate.

In an example embodiment, there is provided an apparatus, in particular according to the first example aspect and/or any one of the first example embodiment of the first example aspect and/or the second example embodiment of the first example aspect described herein, wherein the at least one indication indicates that the at least one timer configuration is to be applied based on reception of a PDCCH order for early TA acquisition.

In an example embodiment, there is provided an apparatus, in particular according to the first example aspect and/or any one of the associated example embodiments described herein, wherein the at least one processor and the at least one memory storing instructions that, when executed by the at least one processor, cause the apparatus at least to perform:
detecting an ongoing or imminent RLF, and
starting at least one timer,
based at least in part on the at least on timer configuration.

In an example embodiment, there is provided an apparatus, in particular according to the first example aspect and/or any one of the associated example embodiments described herein, wherein the message is a LTM Radio Resource Control (RRC) Reconfiguration message.

In an example embodiment, there is provided an apparatus, in particular according to the first example aspect and/or any one of the associated example embodiments described herein, wherein the at least one condition indicates that the RLF is ongoing or imminent based on at least one of:
detecting a failure of at least one beam to the network node,
detecting that a failure recovery of at least one beam to the network node is ongoing,
determining that another timer is running, and/or
expiry of at least one timer associated with the at least one timer configuration.

In an example embodiment, there is provided an apparatus, in particular according to the first example aspect and/or any one of the associated example embodiments described herein, wherein the apparatus is a User equipment (UE) or wherein the apparatus is comprised in a UE.

Furthermore, in particular further according to the first example aspect, there may be provided an apparatus, comprising means for:
receiving at least one Lower Layer Triggered Mobility (LTM) configuration message from a network node, which includes at least one timer configuration for monitoring of an ongoing or imminent Radio Link Failure (RLF),
monitoring at least one beam from the network node based on the at least one timer configuration.

In an example embodiment, there is provided an apparatus, in particular according to the first example aspect described herein, wherein the at least one timer configuration includes at least one timer indicative of a time period for monitoring the ongoing or imminent RLF.

In an example embodiment, there is provided an apparatus, in particular according to the first example aspect and/or any one of the associated example embodiments described herein, wherein the at least one timer configuration includes at least one condition that specifies when ongoing or imminent RLF is to be declared or when at least one timer associated with the at least one timer configuration is to be started.

In an example embodiment, which may be referred to as a first example embodiment of the first example aspect, there is provided an apparatus, in particular according to the first example aspect and/or any one of the associated example embodiments described herein, wherein the at least one timer configuration includes at least one indication that indicates a usage requirement of the at least one timer configuration.

In an example embodiment, which may be referred to as a second example embodiment of the first example aspect, there is provided an apparatus, in particular according to the first example aspect and/or any one of the associated example embodiments described herein, wherein the at least one indication indicates for which events the at least one timer configuration is to be applied.

In an example embodiment, there is provided an apparatus, in particular according to the first example aspect and/or any one of the first example embodiment of the first example aspect and/or the second example embodiment of the first example aspect described herein, wherein the at least one indication indicates at least a first beam of a target cell and at least a second beam of a serving cell for which the at least one timer configuration is to be used.

In an example embodiment, there is provided an apparatus, in particular according to the first example aspect and/or any one of the first example embodiment of the first example aspect and/or the second example embodiment of the first example aspect described herein, wherein the at least one indication indicates at least a requirement for transmission of at least one Layer 1 measurement report to the network node.

In an example embodiment, which may be referred to as a third example embodiment of the first example aspect, there is provided an apparatus, in particular according to the first example aspect and/or any one of the first example embodiment of the first example aspect and/or the second example embodiment of the first example aspect described herein, wherein the at least one indication indicates that the at least one timer configuration is to be applied based on at least one LTM reporting event.

In an example embodiment, there is provided an apparatus, in particular according to the first example aspect and/or the third example embodiment of the first example aspect described herein, wherein the at least one LTM reporting event is a LTM3 reporting event for which a signal strength of a beam from a target cell of the network node is compared to a signal strength of a beam from a serving cell of the network node.

In an example embodiment, there is provided an apparatus, in particular according to the first example aspect and/or the third example embodiment of the first example aspect described herein, wherein the at least one LTM reporting event is a LTM4 reporting event for which a signal strength of a beam from a target cell of the network node is compared to a predefined threshold.

In an example embodiment, there is provided an apparatus, in particular according to the first example aspect and/or any one of the first example embodiment of the first example aspect and/or the second example embodiment of the first example aspect described herein, wherein the at least one indication indicates that the at least one timer configuration is to be applied based on initiation of early Timing Advance (TA) acquisition.

In an example embodiment, there is provided an apparatus, in particular according to the first example aspect and/or any one of the first example embodiment of the first example aspect and/or the second example embodiment of the first example aspect described herein, wherein the at least one indication indicates that the at least one timer configuration is to be applied based on at least one of:
reception of a Target Cell Identity (TCI) state activation command, or
activation of TCI state.

In an example embodiment, there is provided an apparatus, in particular according to the first example aspect and/or any one of the first example embodiment of the first example aspect and/or the second example embodiment of the first example aspect described herein, wherein the at least one indication indicates that the at least one timer configuration is to be applied based on a User Equipment (UE)-TA estimate.

In an example embodiment, there is provided an apparatus, in particular according to the first example aspect and/or any one of the first example embodiment of the first example aspect and/or the second example embodiment of the first example aspect described herein, wherein the at least one indication indicates that the at least one timer configuration is to be applied based on reception of a PDCCH order for early TA acquisition.

In an example embodiment, there is provided an apparatus, in particular according to the first example aspect and/or any one of the associated example embodiments described herein, wherein the means are configured for:
detecting an ongoing or imminent RLF, and starting at least one timer,
based at least in part on the at least on timer configuration.

In an example embodiment, there is provided an apparatus, in particular according to the first example aspect and/or any one of the associated example embodiments described herein, wherein the message is a LTM Radio Resource Control (RRC) Reconfiguration message.

In an example embodiment, there is provided an apparatus, in particular according to the first example aspect and/or any one of the associated example embodiments described herein, wherein the at least one condition indicates that the RLF is ongoing or imminent based on at least one of:
detecting a failure of at least one beam to the network node,
detecting that a failure recovery of at least one beam to the network node is ongoing, determining that another timer is running, and/or
expiry of at least one timer associated with the at least one timer configuration.

In an example embodiment, there is provided an apparatus, in particular according to the first example aspect and/or any one of the associated example embodiments described herein, wherein the apparatus is a User equipment (UE) or wherein the apparatus is comprised in a UE.

In a second example aspect, there may be provided a method, comprising:
receiving at least one Lower Layer Triggered Mobility (LTM) configuration message from a network node, which includes at least one timer configuration for monitoring of an ongoing or imminent Radio Link Failure (RLF),
monitoring at least one beam from the network node based on the at least one timer configuration.

In an example embodiment, there is provided a method, in particular according to the second example aspect described herein, wherein the at least one timer configuration includes at least one timer indicative of a time period for monitoring the ongoing or imminent RLF.

In an example embodiment, there is provided a method, in particular according to the second example aspect and/or any one of the associated example embodiments described herein, wherein the at least one timer configuration includes at least one condition that specifies when ongoing or imminent RLF is to be declared or when at least one timer associated with the at least one timer configuration is to be started.

In an example embodiment, which may be referred to as a first example embodiment of the second example aspect, there is provided a method, in particular according to the second example aspect and/or any one of the associated example embodiments described herein, wherein the at least one timer configuration includes at least one indication that indicates a usage requirement of the at least one timer configuration.

In an example embodiment, which may be referred to as a second example embodiment of the second example aspect, there is provided a method, in particular according to the second example aspect and/or any one of the associated example embodiments described herein, wherein the at least one indication indicates for which events the at least one timer configuration is to be applied.

In an example embodiment, there is provided a method, in particular according to the second example aspect and/or any one of the first example embodiment of the second example aspect and/or the second example embodiment of the second example aspect described herein, wherein the at least one indication indicates at least a first beam of a target cell and at least a second beam of a serving cell for which the at least one timer configuration is to be used.

In an example embodiment, there is provided a method, in particular according to the second example aspect and/or any one of the first example embodiment of the second example aspect and/or the second example embodiment of the second example aspect described herein, wherein the at least one indication indicates at least a requirement for transmission of at least one Layer 1 measurement report to the network node.

In an example embodiment, which may be referred to as a third example embodiment of the second example aspect, there is provided a method, in particular according to the second example aspect and/or any one of the first example embodiment of the second example aspect and/or the second example embodiment of the second example aspect described herein, wherein the at least one indication indicates that the at least one timer configuration is to be applied based on at least one LTM reporting event.

In an example embodiment, there is provided a method, in particular according to the second example aspect and/or the third example embodiment of the second example aspect described herein, wherein the at least one LTM reporting event is a LTM3 reporting event for which a signal strength of a beam from a target cell of the network node is compared to a signal strength of a beam from a serving cell of the network node.

In an example embodiment, there is provided a method, in particular according to the second example aspect and/or the third example embodiment of the second example aspect described herein, wherein the at least one LTM reporting event is a LTM4 reporting event for which a signal strength of a beam from a target cell of the network node is compared to a predefined threshold.

In an example embodiment, there is provided a method, in particular according to the second example aspect and/or any one of the first example embodiment of the second example aspect and/or the second example embodiment of the second example aspect described herein, wherein the at least one indication indicates that the at least one timer configuration is to be applied based on initiation of early Timing Advance (TA) acquisition.

In an example embodiment, there is provided a method, in particular according to the second example aspect and/or any one of the first example embodiment of the second example aspect and/or the second example embodiment of the second example aspect described herein, wherein the at least one indication indicates that the at least one timer configuration is to be applied based on at least one of:
reception of a Target Cell Identity (TCI) state activation command, or
activation of TCI state.

In an example embodiment, there is provided a method, in particular according to the second example aspect and/or any one of the first example embodiment of the second example aspect and/or the second example embodiment of the second example aspect described herein, wherein the at least one indication indicates that the at least one timer configuration is to be applied based on a User Equipment (UE)-TA estimate.

In an example embodiment, there is provided a method, in particular according to the second example aspect and/or any one of the first example embodiment of the second example aspect and/or the second example embodiment of the second example aspect described herein, wherein the at least one indication indicates that the at least one timer configuration is to be applied based on reception of a PDCCH order for early TA acquisition.

In an example embodiment, there is provided a method, in particular according to the second example aspect and/or any one of the associated example embodiments described herein, wherein the means are configured for:
detecting an ongoing or imminent RLF, and
starting at least one timer,
based at least in part on the at least on timer configuration.

In an example embodiment, there is provided a method, in particular according to the second example aspect and/or any one of the associated example embodiments described herein, wherein the message is a LTM Radio Resource Control (RRC) Reconfiguration message.

In an example embodiment, there is provided a method, in particular according to the second example aspect and/or any one of the associated example embodiments described herein, wherein the at least one condition indicates that the RLF is ongoing or imminent based on at least one of:
detecting a failure of at least one beam to the network node,
detecting that a failure recovery of at least one beam to the network node is ongoing, determining that another timer is running, and/or
expiry of at least one timer associated with the at least one timer configuration.

In a third example aspect, there may be provided a non-transitory computer readable storage medium comprising program instructions that, when executed by an apparatus, in particular according to the first example aspect and/or any one of the associated example embodiments described herein, causes operations comprising:
receiving at least one Lower Layer Triggered Mobility (LTM) configuration message from a network node, which includes at least one timer configuration for monitoring of an ongoing or imminent Radio Link Failure (RLF),
monitoring at least one beam from the network node based on the at least one timer configuration.

The third example aspect may further comprise one or more steps and/or features of the method and/or any one of the associated example embodiments recited in the second example aspect.

In a fourth example aspect, there may be provided an apparatus, comprising:
at least one processor; and
at least one memory storing instructions that, when executed by the at least one processor, cause the apparatus at least to perform:
measuring reference signals from a serving cell and a target cell on respective beams associated with at least one timer configuration, wherein the timer configuration specifies when a Radio Link Failure (RLF) is ongoing or imminent, transmitting, based on determining that RLF is ongoing or imminent, a measurement report to a network node which includes at least one indication that indicates that RLF is ongoing or imminent.

In an example embodiment, which may be referred to as a first example embodiment of the fourth example aspect, there is provided an apparatus, in particular according to the fourth example aspect, wherein the at least one timer configuration includes at least one timer indicative of a time period for monitoring of an ongoing or imminent RLF.

In an example embodiment, which may be referred to as a second example embodiment of the fourth example aspect, there is provided an apparatus, in particular according to the fourth example aspect and/or any one of the associated example embodiments described herein, wherein the at least one indication indicates that at least one timer has started.

In an example embodiment, which may be referred to as a third example embodiment of the fourth example aspect, there is provided an apparatus, in particular according to the fourth example aspect and/or any one of the first example embodiment of the fourth example aspect and/or the second example embodiment of the fourth example aspect described herein, wherein the at least one processor and the at least one memory storing instructions that, when executed by the at least one processor, cause the apparatus at least to perform:
starting the at least one timer based at least in part on determining that RLF is ongoing or imminent.

In an example embodiment, which may be referred to as a fourth example embodiment of the fourth example aspect, there is provided an apparatus, in particular according to the fourth example aspect and/or any one of the first example embodiment of the fourth example aspect, the second example embodiment of the fourth example aspect and/or the third example embodiment of the fourth example aspect described herein, wherein the at least one timer is started at a time of transmitting the measurement report.

In an example embodiment, which may be referred to as a fifth example embodiment of the fourth example aspect, there is provided an apparatus, in particular according to the fourth example aspect and/or any one of the associated example embodiments described herein, wherein the measurement report is a Lower Layer Triggered Mobility (LTM) measurement Report or a Layer 1 measurement report.

In an example embodiment, there is provided an apparatus, in particular according to the fourth example aspect and/or any one of the first example embodiment of the fourth example aspect to the fifth example embodiment of the fourth example aspect described herein, wherein the at least one timer configuration indicates at least one beam or at least one beam pair for which the at least one timer is to be applied.

In an example embodiment, which may be referred to as a sixth example embodiment of the fourth example aspect, there is provided an apparatus, in particular according to the fourth example aspect and/or any one of the associated example embodiments described herein, wherein the at least one processor and the at least one memory storing instructions that, when executed by the at least one processor, cause the apparatus at least to perform:
comparing a signal strength of at least one first reference signal measured on a first beam of the serving cell with a signal strength of at least one second reference signal measured on a second beam of the target cell.

In an example embodiment, which may be referred to as a seventh example embodiment of the fourth example aspect, there is provided an apparatus, in particular according to the fourth example aspect and/or the sixth example embodiment of the fourth example aspect described herein, wherein the at least one processor and the at least one memory storing instructions that, when executed by the at least one processor, cause the apparatus at least to perform:
determining that the signal strength of the at least one second reference signal on the second beam of the target cell is greater than the signal strength of the at least one first reference signal on the first beam of the serving cell.

In an example embodiment, which may be referred to as an eighth example embodiment of the fourth example aspect, there is provided an apparatus, in particular according to the fourth example aspect and/or any one of the sixth example embodiment of the fourth example aspect and/or the seventh example embodiment of the fourth example aspect described herein, wherein the at least one processor and the at least one memory storing instructions that, when executed by the at least one processor, cause the apparatus at least to perform:
providing a further indication in the measurement report that indicates a measurement result of comparing the signal strength of the at least one second reference signal with the signal strength of the at least one first reference signal.

In an example embodiment, which may be referred to as a ninth example embodiment of the fourth example aspect, there is provided an apparatus, in particular according to the fourth example aspect and/or any one of the first example embodiment of the fourth example aspect to the eighth example embodiment of the fourth example aspect described herein, wherein the at least one processor and the at least one memory storing instructions that, when executed by the at least one processor, cause the apparatus at least to perform:
stopping the at least one timer based on reception of at least one cell switch command from the network node.

In an example embodiment, there is provided an apparatus, in particular according to the fourth example aspect and/or the ninth example embodiment of the fourth example aspect described herein, wherein the at least one processor and the at least one memory storing instructions that, when executed by the at least one processor, cause the apparatus at least to perform:
initiating at least one LTM cell switch procedure based on reception of the at least one cell switch command from the network node.

In an example embodiment, which may be referred to as a tenth example embodiment of the fourth example aspect, there is provided an apparatus, in particular according to the fourth example aspect and/or any one of the first example embodiment of the fourth example aspect to the eighth example embodiment of the fourth example aspect described herein, wherein the at least one processor and the at least one memory storing instructions that, when executed by the at least one processor, cause the apparatus at least to perform:
determining that the at least one timer expires before reception of at least one cell switch command from the network node.

In an example embodiment, there is provided an apparatus, in particular according to the fourth example aspect and/or the tenth example embodiment of the fourth example aspect described herein, wherein the at least one processor and the at least one memory storing instructions that, when executed by the at least one processor, cause the apparatus at least to perform:
initiating at least one of: a re-establishment procedure or a LTM recovery procedure based on expiry of the at least one timer.

In an example embodiment, there is provided an apparatus, in particular according to the fourth example aspect and/or any one of the associated example embodiments described herein, wherein determining that RLF is ongoing or imminent is based on at least one of:
detecting a failure of at least one beam to the network node,
detecting that a failure recovery of at least one beam to the network node is ongoing, and/or
determining that another timer is running.

In an example embodiment, there is provided an apparatus, in particular according to the fourth example aspect and/or any one of the associated example embodiments described herein, wherein the apparatus is a User equipment (UE) or wherein the apparatus is comprised in a UE.

Furthermore, in particular further according to the fourth example aspect, there may be provided an apparatus, comprising means for:
measuring reference signals from a serving cell and a target cell on respective beams associated with at least one timer configuration, wherein the timer configuration specifies when a Radio Link Failure (RLF) is ongoing or imminent, transmitting, based on determining that RLF is ongoing or imminent, a measurement report to a network node which includes at least one indication that indicates that RLF is ongoing or imminent.

In an example embodiment, which may be referred to as a first example embodiment of the fourth example aspect, there is provided an apparatus, in particular according to the fourth example aspect, wherein the at least one timer configuration includes at least one timer indicative of a time period for monitoring of an ongoing or imminent RLF.

In an example embodiment, which may be referred to as a second example embodiment of the fourth example aspect, there is provided an apparatus, in particular according to the fourth example aspect and/or any one of the associated example embodiments described herein, wherein the at least one indication indicates that at least one timer has started.

In an example embodiment, which may be referred to as a third example embodiment of the fourth example aspect, there is provided an apparatus, in particular according to the fourth example aspect and/or any one of the first example embodiment of the fourth example aspect and/or the second example embodiment of the fourth example aspect described herein, wherein the means are configured for:
starting the at least one timer based at least in part on determining that RLF is ongoing or imminent.

In an example embodiment, which may be referred to as a fourth example embodiment of the fourth example aspect, there is provided an apparatus, in particular according to the fourth example aspect and/or any one of the first example embodiment of the fourth example aspect, the second example embodiment of the fourth example aspect and/or the third example embodiment of the fourth example aspect described herein, wherein the at least one timer is started at a time of transmitting the measurement report.

In an example embodiment, which may be referred to as a fifth example embodiment of the fourth example aspect, there is provided an apparatus, in particular according to the fourth example aspect and/or any one of the associated example embodiments described herein, wherein the measurement report is a Lower Layer Triggered Mobility (LTM) measurement Report or a Layer 1 measurement report.

In an example embodiment, there is provided an apparatus, in particular according to the fourth example aspect and/or any one of the first example embodiment of the fourth example aspect to the fifth example embodiment of the fourth example aspect described herein, wherein the at least one timer configuration indicates at least one beam or at least one beam pair for which the at least one timer is to be applied.

In an example embodiment, which may be referred to as a sixth example embodiment of the fourth example aspect, there is provided an apparatus, in particular according to the fourth example aspect and/or any one of the associated example embodiments described herein, wherein the means are configured for:
comparing a signal strength of at least one first reference signal measured on a first beam of the serving cell with a signal strength of at least one second reference signal measured on a second beam of the target cell.

In an example embodiment, which may be referred to as a seventh example embodiment of the fourth example aspect, there is provided an apparatus, in particular according to the fourth example aspect and/or the sixth example embodiment of the fourth example aspect described herein, wherein the means are configured for:
determining that the signal strength of the at least one second reference signal on the second beam of the target cell is greater than the signal strength of the at least one first reference signal on the first beam of the serving cell.

In an example embodiment, which may be referred to as an eighth example embodiment of the fourth example aspect, there is provided an apparatus, in particular according to the fourth example aspect and/or any one of the sixth example embodiment of the fourth example aspect and/or the seventh example embodiment of the fourth example aspect described herein, wherein the means are configured for:
providing a further indication in the measurement report that indicates a measurement result of comparing the signal strength of the at least one second reference signal with the signal strength of the at least one first reference signal.

In an example embodiment, which may be referred to as a ninth example embodiment of the fourth example aspect, there is provided an apparatus, in particular according to the fourth example aspect and/or any one of the first example embodiment of the fourth example aspect to the eighth example embodiment of the fourth example aspect described herein, wherein the means are configured for:
stopping the at least one timer based on reception of at least one cell switch command from the network node.

In an example embodiment, there is provided an apparatus, in particular according to the fourth example aspect and/or the ninth example embodiment of the fourth example aspect described herein, wherein the means are configured for:
initiating at least one LTM cell switch procedure based on reception of the at least one cell switch command from the network node.

In an example embodiment, which may be referred to as a tenth example embodiment of the fourth example aspect, there is provided an apparatus, in particular according to the fourth example aspect and/or any one of the first example embodiment of the fourth example aspect to the eighth example embodiment of the fourth example aspect described herein, wherein the means are configured for:
determining that the at least one timer expires before reception of at least one cell switch command from the network node.

In an example embodiment, there is provided an apparatus, in particular according to the fourth example aspect and/or the tenth example embodiment of the fourth example aspect described herein, wherein the means are configured for:
initiating at least one of: a re-establishment procedure or a LTM recovery procedure based on expiry of the at least one timer.

In an example embodiment, there is provided an apparatus, in particular according to the fourth example aspect and/or any one of the associated example embodiments described herein, wherein determining that RLF is ongoing or imminent is based on at least one of:
detecting a failure of at least one beam to the network node,
detecting that a failure recovery of at least one beam to the network node is ongoing, and/or
determining that another timer is running.

In an example embodiment, there is provided an apparatus, in particular according to the fourth example aspect and/or any one of the associated example embodiments described herein, wherein the apparatus is a User equipment (UE) or wherein the apparatus is comprised in a UE.

In a fifth example aspect, there may be provided a method, comprising:
measuring reference signals from a serving cell and a target cell on respective beams associated with at least one timer configuration, wherein the timer configuration specifies when a Radio Link Failure (RLF) is ongoing or imminent, transmitting, based on determining that RLF is ongoing or imminent, a measurement report to a network node which includes at least one indication that indicates that RLF is ongoing or imminent.

In an example embodiment, which may be referred to as a first example embodiment of the fifth example aspect, there is provided a method, in particular according to the fifth example aspect, wherein the at least one timer configuration includes at least one timer indicative of a time period for monitoring of an ongoing or imminent RLF.

In an example embodiment, which may be referred to as a second example embodiment of the fifth example aspect, there is provided a method, in particular according to the fifth example aspect and/or any one of the associated example embodiments described herein, wherein the at least one indication indicates that at least one timer has started.

In an example embodiment, which may be referred to as a third example embodiment of the fifth example aspect, there is provided a method, in particular according to the fifth example aspect and/or any one of the first example embodiment of the fifth example aspect and/or the second example embodiment of the fifth example aspect described herein, wherein the method comprises:
starting the at least one timer based at least in part on determining that RLF is ongoing or imminent.

In an example embodiment, which may be referred to as a fourth example embodiment of the fifth example aspect, there is provided a method, in particular according to the fifth example aspect and/or any one of the first example embodiment of the fifth example aspect, the second example embodiment of the fifth example aspect and/or the third example embodiment of the fifth example aspect described herein, wherein the at least one timer is started at a time of transmitting the measurement report.

In an example embodiment, which may be referred to as a fifth example embodiment of the fifth example aspect, there is provided a method, in particular according to the fifth example aspect and/or any one of the associated example embodiments described herein, wherein the measurement report is a Lower Layer Triggered Mobility (LTM) measurement Report or a Layer 1 measurement report.

In an example embodiment, there is provided a method, in particular according to the fifth example aspect and/or any one of the first example embodiment of the fifth example aspect to the fifth example embodiment of the fifth example aspect described herein, wherein the at least one timer configuration indicates at least one beam or at least one beam pair for which the at least one timer is to be applied.

In an example embodiment, which may be referred to as a sixth example embodiment of the fifth example aspect, there is provided a method, in particular according to the fifth example aspect and/or any one of the associated example embodiments described herein, wherein the method comprises:
comparing a signal strength of at least one first reference signal measured on a first beam of the serving cell with a signal strength of at least one second reference signal measured on a second beam of the target cell.

In an example embodiment, which may be referred to as a seventh example embodiment of the fifth example aspect, there is provided a method, in particular according to the fifth example aspect and/or the sixth example embodiment of the fifth example aspect described herein, wherein the method comprises:
determining that the signal strength of the at least one second reference signal on the second beam of the target cell is greater than the signal strength of the at least one first reference signal on the first beam of the serving cell.

In an example embodiment, which may be referred to as an eighth example embodiment of the fifth example aspect, there is provided a method, in particular according to the fifth example aspect and/or any one of the sixth example embodiment of the fifth example aspect and/or the seventh example embodiment of the fifth example aspect described herein, wherein the method comprises:
providing a further indication in the measurement report that indicates a measurement result of comparing the signal strength of the at least one second reference signal with the signal strength of the at least one first reference signal.

In an example embodiment, which may be referred to as a ninth example embodiment of the fifth example aspect, there is provided a method, in particular according to the fifth example aspect and/or any one of the first example embodiment of the fifth example aspect to the eighth example embodiment of the fifth example aspect described herein, wherein the method comprises:
stopping the at least one timer based on reception of at least one cell switch command from the network node.

In an example embodiment, there is provided a method, in particular according to the fifth example aspect and/or the ninth example embodiment of the fifth example aspect described herein, wherein the method comprises:
initiating at least one LTM cell switch procedure based on reception of the at least one cell switch command from the network node.

In an example embodiment, which may be referred to as a tenth example embodiment of the fifth example aspect, there is provided a method, in particular according to the fifth example aspect and/or any one of the first example embodiment of the fifth example aspect to the eighth example embodiment of the fifth example aspect described herein, wherein the method comprises:
determining that the at least one timer expires before reception of at least one cell switch command from the network node.

In an example embodiment, there is provided a method, in particular according to the fifth example aspect and/or the tenth example embodiment of the fifth example aspect described herein, wherein the method comprises:
initiating at least one of: a re-establishment procedure or a LTM recovery procedure based on expiry of the at least one timer.

In an example embodiment, there is provided a method, in particular according to the fifth example aspect and/or any one of the associated example embodiments described herein, wherein determining that RLF is ongoing or imminent is based on at least one of:
detecting a failure of at least one beam to the network node,
detecting that a failure recovery of at least one beam to the network node is ongoing, and/or
determining that another timer is running.

In a sixth example aspect, there may be provided a non-transitory computer readable storage medium comprising program instructions that, when executed by an apparatus, in particular according to the fourth example aspect, and/or any one of the associated example embodiments described herein, causes operations comprising:
measuring reference signals from a serving cell and a target cell on respective beams associated with at least one timer configuration, wherein the timer configuration specifies when a Radio Link Failure (RLF) is ongoing or imminent, transmitting, based on determining that RLF is ongoing or imminent, a measurement report to a network node which includes at least one indication that indicates that RLF is ongoing or imminent.

The sixth example aspect may further comprise one or more steps and/or features of the method and/or any one of the associated example embodiments recited in the fifth example aspect.

In a seventh example aspect, in particular which may be combined with any one of the example aspects and/or any one of the associated example embodiments described herein, there may be provided a signal or an electronic carrier, with embedded data, being encoded in accordance with an encoding process, which comprises:
providing at least one Lower Layer Triggered Mobility (LTM) configuration message, which includes at least one timer configuration for monitoring of an ongoing or imminent Radio Link Failure (RLF).

In an example embodiment, there is provided a signal or an electronic carrier, in particular according to the seventh example aspect described herein, wherein the at least one timer configuration includes at least one timer indicative of a time period for monitoring the ongoing or imminent RLF.

In an example embodiment, there is provided a signal or an electronic carrier, in particular according to the seventh example aspect and/or any one of the associated example embodiments described herein, wherein the at least one timer configuration includes at least one condition that specifies when ongoing or imminent RLF is to be declared or when at least one timer associated with the at least one timer configuration is to be started.

In an example embodiment, which may be referred to as a first example embodiment of the seventh example aspect, there is provided a signal or an electronic carrier, in particular according to the seventh example aspect and/or any one of the associated example embodiments described herein, wherein the at least one timer configuration includes at least one indication that indicates a usage requirement of the at least one timer configuration.

In an example embodiment, which may be referred to as a second example embodiment of the seventh example aspect, there is provided a signal or an electronic carrier, in particular according to the seventh example aspect and/or any one of the associated example embodiments described herein, wherein the at least one indication indicates for which events the at least one timer configuration is to be applied.

In an example embodiment, there is provided a signal or an electronic carrier, in particular according to the seventh example aspect and/or any one of the first example embodiment of the seventh example aspect and/or the second example embodiment of the seventh example aspect described herein, wherein the at least one indication indicates at least a first beam of a target cell and at least a second beam of a serving cell for which the at least one timer configuration is to be used.

In an example embodiment, there is provided a signal or an electronic carrier, in particular according to the seventh example aspect and/or any one of the first example embodiment of the seventh example aspect and/or the second example embodiment of the seventh example aspect described herein, wherein the at least one indication indicates at least a requirement for transmission of at least one Layer 1 measurement report to the network node.

In an example embodiment, there is provided a signal or an electronic carrier, in particular according to the seventh example aspect and/or any one of the first example embodiment of the seventh example aspect and/or the second example embodiment of the seventh example aspect described herein, wherein the at least one indication indicates that the at least one timer configuration is to be applied based on at least one LTM reporting event.

In an example embodiment, there is provided a signal or an electronic carrier, in particular according to the seventh example aspect and/or any one of the first example embodiment of the seventh example aspect, the second example embodiment of the seventh example aspect and the preceding example embodiment of the seventh example aspect described herein, wherein the at least one LTM reporting event is a LTM3 reporting event for which a signal strength of a beam from a target cell of the network node is compared to a signal strength of a beam from a serving cell of the network node.

In an example embodiment, there is provided a signal or an electronic carrier, in particular according to the seventh example aspect and/or any one of the first example embodiment of the seventh example aspect, the second example embodiment of the seventh example aspect and the preceding example embodiment of the seventh example aspect described herein, wherein the at least one LTM reporting event is a LTM4 reporting event for which a signal strength of a beam from a target cell of the network node is compared to a predefined threshold.

In an example embodiment, there is provided a signal or an electronic carrier, in particular according to the seventh example aspect and/or any one of the first example embodiment of the seventh example aspect and/or the second example embodiment of the seventh example aspect described herein, wherein the at least one indication indicates that the at least one timer configuration is to be applied based on initiation of early Timing Advance (TA) acquisition.

In an example embodiment, there is provided a signal or an electronic carrier, in particular according to the seventh example aspect and/or any one of the first example embodiment of the seventh example aspect and/or the second example embodiment of the seventh example aspect described herein, wherein the at least one indication indicates that the at least one timer configuration is to be applied based on at least one of:
reception of a Target Cell Identity (TCI) state activation command, or
activation of TCI state.

In an example embodiment, there is provided a signal or an electronic carrier, in particular according to the seventh example aspect and/or any one of the first example embodiment of the seventh example aspect and/or the second example embodiment of the seventh example aspect described herein, wherein the at least one indication indicates that the at least one timer configuration is to be applied based on a User Equipment (UE)-TA estimate.

In an example embodiment, there is provided a signal or an electronic carrier, in particular according to the seventh example aspect and/or any one of the first example embodiment of the seventh example aspect and/or the second example embodiment of the seventh example aspect described herein, wherein the at least one indication indicates that the at least one timer configuration is to be applied based on reception of a PDCCH order for early TA acquisition.

In an example embodiment, there is provided a signal or an electronic carrier, in particular according to the seventh example aspect and/or any one of the associated example embodiments described herein, wherein the message is a LTM Radio Resource Control (RRC) Reconfiguration message.

In an eighth example aspect, in particular which may be combined with any one of the example aspects and/or any one of the associated example embodiments described herein, there may be provided a signal or an electronic carrier, with embedded data, being encoded in accordance with an encoding process, which comprises:
providing a measurement report which includes at least one indication that indicates that RLF is ongoing or imminent.

In an example embodiment, there is provided a signal or an electronic carrier, in particular according to the eighth example aspect described herein, wherein the at least one indication indicates that at least one timer has started.

In an example embodiment, there is provided a signal or an electronic carrier, in particular according to the eighth example aspect and/or any one of the associated example embodiments described herein, wherein the measurement report is a Lower Layer Triggered Mobility (LTM) measurement Report or a Layer 1 measurement report.

In an example embodiment, there is provided a signal or an electronic carrier, in particular according to the eighth example aspect and/or any one of the associated example embodiments described herein, wherein the encoding process comprises:
providing a further indication in the measurement report that indicates a measurement result of comparing a signal strength of at least one second reference signal on a second beam from a target cell with a signal strength of at least one first reference signal on a first beam from a serving cell.

### DESCRIPTION OF THE DRAWINGS

Some example embodiments will now be described with reference to the accompanying drawings.

A full and enabling disclosure to one of ordinary skill in the art is set forth more particularly in the remainder of the specification including reference to the accompanying drawings wherein:

FIG. 1 shows an example signaling according to subject-matter described herein, wherein an apparatus, e.g. a UE, receives or is configured with at least one timer configuration;

FIG. 2 shows an example signaling according to subject-matter described herein, wherein an apparatus, e.g. a UE, transmits a measurement report;

FIG. 3 shows an example signaling according to subject-matter described herein, in particular an exemplary cell change scenario from Cell 1 to Cell 2;

FIG. 4 shows an example signaling according to subject-matter described herein, in particular an exemplary cell change scenario from Cell 1 to Cell 2;

FIG. 5 shows an example signaling according to subject-matter described herein, wherein an apparatus, e.g. a UE, receives or is configured with at least one timer configuration;

FIG. 6 shows an example signaling according to subject-matter described herein, wherein an apparatus, e.g. a UE, transmits a measurement report;

FIG. 7 shows an example signaling according to subject-matter described herein, in particular an exemplary cell change scenario from Cell 1 to Cell 2;

FIG. 8 shows an example signaling according to subject-matter described herein, in particular an exemplary cell change scenario from Cell 1 to Cell 2;

FIG. 9 shows a flow chart of an example aspect of the subject-matter described herein; and

FIG. 10 shows a flow chart of an example aspect of the subject-matter described herein..

### DETAILED DESCRIPTION

Reference will now be made in detail to the various embodiments, one or more examples of which are illustrated in the figures. Within the following description of the drawings, the same reference numbers may refer to same components. Generally, only the differences with respect to individual embodiments may be described. Each example may be provided by way of explanation and is not meant as a limitation. Further, features illustrated or described as part of one embodiment can be used on or in conjunction with other embodiments to yield yet a further embodiment. It is intended that the description includes such modifications and variations.

The drawings are schematic drawings which are not drawn to scale. Some elements in the drawings may have dimensions which are exaggerated for the purpose of highlighting aspects of the present disclosure and/or for the sake of clarity of presentation.

“Lower Layer Triggered Mobility” “(LTM) or “Layer 1 (L1)/Layer 2 (L2) Triggered Mobility” may refer to mobility procedures, e.g. initiated in a cellular network based on events and/or measurements detected at lower layers of a protocol stack-for example, a physical layer or Layer 1 and/or a data link layer or Layer 2 etc. LTM may provide mechanisms, e.g. for a network node and User Equipment (UE), to address mobility needs, complementing, e.g., higher-layer (e.g. Layer 3 or Radio Resource Control (RRC)) mobility processes. LTM may include a cell switch procedure, e.g. where a UE's serving cell (for example a Primary Cell (PCell) or a Secondary Cell (SCell)) may be switched, e.g. by a network node, for example by sending a message, e.g. a LTM cell switch command. A LTM cell switch-decision may be based on measurements (for example L1 measurements) that may be performed and/or reported (for example via a corresponding L1 measurement report), e.g. by the UE. Measurements and/or reporting may be based on a LTM configuration e.g. a LTM candidate cell (or target cell) configuration, e.g. provided by the network node, e.g. for one or more LTM candidate (or target) cells. A LTM candidate or target cell may be a neighboring cell or a UE's current serving cell (e.g. SCell(s)).

L1 (Layer 1) measurements may include physical-layer measurements to evaluate radio conditions. These measurements may involve assessing signal strength, quality, and/or other parameters, e.g. of reference signals transmitted by a network node, e.g. using one or more beams. L1 measurements may be used for mobility management, such as handovers, beam management, and/or connection re-establishments. In order to select appropriate candidate cells and/or beams, e.g. for early uplink and/or downlink synchronization and/or cell switching in LTM, both intra-frequency L1 measurements and/or inter-frequency L1 measurements, e.g. using synchronization signal block (SSB) transmissions from the candidate cells, may be supported and/or utilized. Intra-frequency L1 measurements may refer to measurements performed on reference signals, e.g. transmitted on a same carrier frequency as a serving cell, which may be used to, e.g. evaluate the serving cell's signal quality. Inter-frequency L1 measurements may refer to measurements performed on reference signals, e.g. transmitted on frequencies different from the serving cell's carrier frequency, which may be used to, e.g. evaluate the signal quality of cells or beams operating on different frequency layers. Reference Signals used for L1 measurements may include Synchronization Signal Blocks (SSBs).

A “Synchronization Signal Block” or “SSB” may be regarded as an element, a component or signaling, or it may be at least part of a signaling, that may be used in wireless communication, such as for example 5G New Radio (NR). The SSB may provide signals, channels, elements and/or information that enable an apparatus, e.g. a UE, to, in particular initially, connect and/or stay synchronized with a network node, e.g. allowing the UE, for example, to communicate effectively over the network. The at least one SSB may be part of a signaling in which a plurality of SSBs are transmitted, e.g. one after another, successively, consecutively and/or periodically. For example, the signaling may include at least a first SSB and at least a second SSB, which for example may be transmitted (e.g. timely) after the first SSB. This may be also referred to as a sequence or series of SSBs. Each SSB may include Synchronization Signals (SS), e.g. also referred to as a “Primary Synchronization Signal” (PSS) and a “Secondary Synchronization Signal” (SSS). This PSS may allow the UE to detect and/or identify the presence of a cell. The PSS may provide coarse synchronization in terms of timing and frequency. Once the UE detects the PSS, the UE may use the SSS to gain finer synchronization, determining more specific timing and frequency alignment. Together with the PSS, the SSS may assist the UE in, for example, identifying a specific cell ID. In an example, the PSS may be located or included in a first OFDM symbol of the SSB, occupying specific/defined subcarriers therein. In an example, the SSS may be located or included in a third OFDM symbol of the SSB, occupying specific/defined subcarriers therein. The SSB recited herein may include (e.g. in addition to the synchronization signal(s)) at least one “Physical Broadcast Channel” (PBCH). A PBCH may span over a single symbol or over multiple symbols in the SSB and/or a number of subcarriers therein.

For L1 measurements, L1 Reference Signal Received Power (L1-RSRP) may be used as a measurement quantity. For example, for each prepared candidate cell, the network node may provide configuration information about SSBs to measure, e.g. by the UE. One or more measurement Reference Signal (RS) sets may be used. A measurement RS set may guide, e.g. the UE, to which RS to measure and/or which cells/beams to focus on. A measurement RS set may include, e.g. one or more SSB indices (e.g. identifying a SSB to be measured), to be measured from one or more candidate cells; which may be provided to the UE. This configuration may be provided in a LTM configuration, e.g. independent of any candidate or current source cell configuration so that the configuration can be used over multiple cell switches. Additionally, to trigger the UE to make measurements, reporting may be used and/or activated. For LTM, similar to serving cell CSI measurement reporting, different types of L1 reporting, including periodic reporting (e.g. sending L1 measurements reports at defined/fixed intervals, e.g. for regular updates, e.g. when conditions change), semi-persistent reporting (e.g. reports may be sent periodically, but less frequent, e.g. can be triggered based on predefined events and/or conditions, e.g. to reduce overhead), and aperiodic reporting (e.g. may be triggered dynamically, e.g. when specific events and/or conditions occur), may be enabled.

A set of reporting configurations can be provided within each cell's respective configuration, for example because a reporting configuration can contain details of cell-specific uplink resources to send reports, in particular when the reports are configured to be sent on uplink control channels, e.g. with pre-configured resources. For example, if reports are sent on uplink control channels, the cell may need to allocate, e.g. pre-configured, uplink resources (e.g., Physical Uplink Control Channel, PUCCH) for the UE to send reports. A reporting configuration may also contain a reference to a measurement RS set, e.g. located in the LTM configuration to be considered for measurements. The details of the reporting content may include a number of candidate cells (L) and a number of SSBs, e.g. per candidate cell (M) to be reported from the measurements made by the UE. In each LTM report, the UE can send MxL measurements (e.g. L1-RSRPs values) where supported values for each M and L can be {1, 2, 3, 4}. The reporting format may follow the beam management reporting format, where the largest L1-RSRP is reported as the absolute value using 7 bits, and other L1-RSRPs are reported using 4-bit differential values. The measurement RS sets may be prepared by a control unit (CU) of distributed units (DUs) controlling the source and/or candidate cells. The measurement RS sets may be sent to each candidate and source cell, e.g. to prepare cell-specific reporting configurations. These configurations may then be sent back to the CU, which can add the configurations to a complete LTM RRC Reconfiguration and send them to the UE.

Lower Layer Triggered Mobility (LTM) may include or define reporting events like LTM2, LTM3, LTM4, and LTM5 events, which may define specific conditions, events and/or scenarios under which the UE may send one or more measurement reports, e.g. to assist with mobility decisions. These events may be tied to measurements of Layer 1 (L1 ) parameters, like L1-RSRP, and may be used for handovers and/or mobility management. The following is a non-limiting, list of example LTM reporting events, e.g. where at least one radio link or at least one beam becomes worse or degrades, and it should be noted that others are also conceivable:
LTM2 Event: This event may occur, e.g. when a signal strength of a beam of a serving cell falls below or becomes lower than an, e.g. absolute, threshold.

LTM3 Event: This event may occur e.g. when a signal strength of a beam of a candidate or target cell becomes, e.g. better or stronger, than a signal strength of a beam of serving cell;

LTM4 Event: This event may occur e.g. when a signal strength of a beam of a candidate or target cell becomes better than an, e.g. absolute, threshold,

LTM5 Event: This event may occur e.g. when a signal strength of a beam of a serving cell becomes worse than the, e.g. absolute, threshold and a signal strength of a beam of a candidate or target cell becomes better than another, e.g. absolute, threshold.

A “LTM Configuration message” may be understood as at least one message, e.g. from a network node, to configure an apparatus, e.g. a User Equipment (UE), for one or more parts or steps of a LTM process and/or a LMT procedure, for example a LTM cell switch. The LTM message may comprise data, information, configurations, parameters and/or instructions, e.g. for the UE, e.g. to perform and/or trigger mobility-related measurements and/or reporting. The LTM configuration message as described herein may configure the UE for early Radio Link Failure and/or early RLF detection, in particular for early Radio Link Failure detection on a beam-level.

A “Radio Link Failure” (RLF) may refer to a condition, a state and/or a status of a link, e.g. a communication link, a beam or a radio link, between two parties, e.g. two apparatuses such as for example a User Equipment (UE) and a network node, e.g. a serving cell thereof, wherein the link becomes unstable, volatile, instable, fragile, deteriorates e.g. becomes poor(er), e.g. in terms of quality, and/or the link fails or is about to fail. It may also refer to a situation in which the connection provided by the link cannot be maintained, e.g. partly or fully. Occurrence of a RLF may lead to a loss of service(s), functionality(-ies) and/or the connection itself. A RLF may be caused, for example by a low signal strength, e.g. moving out of coverage area or a cell border, high interference, e.g. due to other apparatuses, hardware failure, e.g. UE or network node, network congestion, e.g. leading to resources being unavailable and/or poor link quality, e.g. due to environmental factors such as obstacle(s) and/or weather, or the like.

An “early RLF” may correspond to a situation in which a RLF “is about to occur”, e.g. when it is determined, detected, monitored, identified and/or noticed that a radio link is deteriorating and is likely to or will fail soon. This may be referred to as an upcoming RLF, an impending RLF, an imminent RLF, a forthcoming RLF, an approaching RLF, a potential RLF and/or a looming RLF-or simply as early RLF (these terms may be used interchangeably herein). In other words, the link may deteriorate to a point where the link can no longer support reliable communication. Determining that the RLF is about to occur may be carried out by an apparatus, e.g. a UE. For example, the UE may monitor, observe, watch, measure, surveil and/or track the radio link to determine and/or detect that an RLF is about to occur. By identifying such warning signs early, the UE and/or the network node can take proactive measures to avoid a complete link/connection failure. Determining an early RLF may include determining that an initially good radio link is deteriorating as mentioned above, but it may also include a situation in which it may be determined that an RLF is (still) ongoing, e.g. that the radio situation maintains in this deteriorated state, that it has not or not significantly improved and/or that it is even further deteriorating.

There are multiple ways to determine RLF. For example, the UE may, in particular continuously, monitor, e.g. a quality of the radio link and/or radio signals. The UE may perform i) signal quality measurements, including measure a strength of at least one, in particular reference signal (Reference Singal Received Power, “RSRP”), which may be threshold based, e.g. if RSRP falls below a predefined threshold, the UE may consider the link to be in danger of failure. The UE may measure the signal quality relative to noise and/or interference (Reference Signal Received Quality, “RSRQ”), e.g. a, in particular sharp, drop in RSRQ may indicate worsening link conditions and an impending RLF. The UE may determine ii) Error Rates and/or Decoding Failures, including Block Error Rate (BLER), e.g. tracking a rate of errors in the data blocks received, which may be threshold-based, e.g. a high BLER may indicate that the link is becoming unreliable; HARQ (Hybrid Automatic Repeat Request) Retransmissions), e.g. the UE may monitors the number of retransmissions required to successfully decode data, wherein frequent and/or excessive retransmissions may suggest link degradation. The UE may determine iii) Timing Advance (TA) Drifts, e.g. large and/or frequent variations in the TA value may indicate issues with signal propagation and/or link quality, signaling a potential RLF. The UE may determine iv) Loss of Synchronization, e.g. as the UE may maintain synchronization with the base station for both uplink and/or downlink transmissions, the UE may declare an Out-of-Sync (OoS) condition, e.g. if the UE fails to decode critical references signals over, in particular consecutive, subframes. The UE may determine v) Physical Uplink Control Channel (PUCCH) Transmission Failures, e.g. failure to transmit acknowledgments, control information, and/or scheduling requests could indicate uplink instability. The UE may determine vi) Handover failures, e.g. if the UE cannot successfully hand over to a stronger neighboring cell when the signal deteriorates, it may face an imminent RLF. The UE may determine vii) Interference, e.g. the UE may detect increasing inter-cell and/or intra-cell interference levels, which can degrade signal quality and/or lead to RLF. In other words, the UE may monitor one or more parameter(s) as above and when these metrics cross, e.g. predefined thresholds, the UE may predict that the link is about to fail. The UE may also combine one or more of the aforementioned indicators i)-vii) to provide a more robust/reliable detection of an imminent RLF. Upon detecting that an RLF is imminent (i.e., the link is degrading and/or close to failure), the UE may take proactive action by initiating a request to prevent complete link loss and/or ensure robust connectivity as mentioned herein.

A network or “network node” or base station may correspond to an apparatus or a, in particular functional, element in a mobile or cellular network responsible for managing radio communication with another apparatus, e.g. a UE, and/or handling Control Plane (CP) and/or User Plane (UP) operations/functionalities. In a non-limiting example, a fifth Generation (5G) network node may be referred to as gNodeB (gNB), which may include a Centralized Unit (CU), which may manage control plane signaling and/or higher-layer functions like Radio Resource Control (RRC), and a Distributed Unit (DU), which may may handle lower-layer functions and/or user plane data, e.g. closer to the radio interface. A network node may be divided into and/or comprise different, in particular serving, cells, in particular at least one first cell and at least one second cell. The first cell may be regarded as a, in particular currently, service cell and/or a main or primary service cell that, e.g. establishes and/or maintains the connection to the UE. In the non-limiting example of 5G, the at least one first cell may correspond to at least one Primary Cell (PCell), which may handle and/or be tied to CP related functionalities, such as initial connection setup, e.g. RRC protocol, handling signaling messages, mobility management (e.g. handovers) and/or radio resources management. The second cell may be regarded as an additional cell, e.g. in addition to the at least one first cell, e.g. to enhance connectivity and/or data throughput. The at least one second cell may be used for data transmissions. In the non-limiting example of 5G, the at least one second cell may correspond to at least one Secondary Cell (SCell) used for user plane data transmission, e.g. to increase throughput and/or capacity.

A “timer configuration” may be regarded as a setup, settings, parameters and/or a configuration for a LTM procedure that may be used by the UE, e.g. for an early RLF detection, e.g. to determine that a RLF is imminent or ongoing as mentioned above. The timer configuration may control and/or indicate a duration for which the UE monitors for, e.g., a specific condition, such as a Radio Link Problem (RLP) or early RLF. The timer configuration may include at least one timer, e.g. which may be referred to as a T31x timer, indicative of a time period, time window, time slot and/or time duration, for monitoring the ongoing or imminent RLF. The timer configuration may also include one or more timer parameters, e.g. a start time, a stop time, a duration and/or one or more expiry criteria. The at least one timer configuration, in particular the at least one timer may be a LTM specific timer configuration, in particular a LTM specific timer, e.g. to be utilized at least during one or more (or all) parts of a LTM procedure, e.g. a LTM cell switch procedure. The timer configuration may be prepared, specified and/or provided by the network node. The at least one timer may enable the UE and network to act before severe link degradation leads to connection loss. By resolving issues within timer durations, unnecessary signaling or re-establishment may be avoided. The at least one timer may be used in a LTM process, e.g. providing a framework for time-bound monitoring, reporting, and/or recovery.

The at least one timer configuration may include at least one condition that specifies when a RLF is ongoing or imminent. The at least one condition may define, specify and/or indicate one or more criteria, parameters and/or states when a RLF is considered to be present, expected, approaching, declared, likely to happen or continuing, ongoing, currently happening. The at least one condition may also indicate and/or specify when at least one timer associated with and/or included in the at least one timer configuration is to be started and/or triggered. The at least one condition may be used to classify, declare, identify and/or categorize poor radio link quality, early RLF and/or ongoing RLF. The at least one condition may indicate or declare that the RLF is ongoing or imminent based on at least one of i) detecting a failure of at least one beam to the network node, wherein such failures may be due to poor signal quality, interference, etc. which may indicate that the communication link between the UE and the network is compromised; ii) detecting that a failure recovery of at least one beam to the network node is ongoing, e.g. referring to an ongoing process of recovering from a failure of one or more beams, which is indicative of link instability; iii) determining that another timer is running or active, e.g. which may suggest that the network is already in a state of transition or recovery, which can impact the timing and/or urgency of actions needed to prevent an RLF, and/or iv) based on expiry of at least one timer associated with the at least one timer configuration.

In addition or alternatively thereto, the at least one timer configuration may include at least one indication that indicates as usage requirement of the at least one timer configuration and/or one or more of the elements, parts, components and/or constituents included in the timer configuration. In other words, the indication may indicate when i) the timer configuration as a whole or ii) one or more of the elements, parts, components and/or constituents thereof, e.g. the at least one timer, the at least one condition etc. is to be used, applied. Thus, when reference to the “timer configuration” is made, it may correspondingly/respectively refer to the preceding cases i) and/or ii). The at least one indication may indicate for which event(s), circumstance(s), case(s) and/or criterion/criteria the at least one timer configuration is to be applied, used or for which it is applicable/usable. In other words, the indication may specify certain situations in which the timer configuration should be used.

The apparatus, e.g. the UE, may perform the step of determining, based on the at least one LTM configuration message, of at least one of:
the at least one timer configuration (e.g. as a whole), and/or one or more parts, elements and/or components thereof,
the at least one timer, indicative of a time period for monitoring the ongoing or imminent RLF,
the at least one condition that specifies when RLF is ongoing or imminent, and/or
the at least one indication that indicates a usage requirement of the at least one timer configuration.

The “indication”, as mentioned herein, may be a flag, indicator, identifier and/or pointer, which may be included or encoded, e.g. in the LTM configuration message and/or the measurement report, in particular the Lower Layer Triggered Mobility (LTM) measurement report or the L1 measurement report, as described herein, e.g. by using, for example, one or more bits.

The indication may be an explicit indication, e.g. which may be, in particular directly, readable or retrievable by the apparatus, e.g. the UE. In addition or alternatively, the indication may correspond to: data/information for determining, deriving and/or concluding to the indication, e.g. an implicit indication. For example, “determining an indication”, e.g. based on the at least one timer configuration, may therefore be understood in i) accessing, reading and/or extracting the indication from the at least one timer configuration, e.g. directly; or ii) deriving, computing and/or inferring the indication from data/information, e.g. indirectly. As such, the indication included in the at least one timer configuration may be referred to as an explicit indication, e.g. if the indication is readable, or as an implicit indication, e.g. if the indication is derivable. In case of an implicit indication, data or information for determining or deriving the indication may be provided as mentioned above. Such data or information may be another information element to which the indication has been embedded. In such a case, the UE may first decode the information element and then derive the indication (and another indication) from the information element. It should be noted that it is not necessary to explicitly refer to “explicit/implicit” with respect to the indication(s), as this fact may simply follow from the terms alone, e.g. “indication” (e.g. explicit), or “data or information” to determine/derive the same, e.g. implicit. The same may correspondingly apply, e.g. in cases when the apparatus, e.g. the UE, provides the indication, e.g. when including the same in the measurement report, in particular the Lower Layer Triggered Mobility (LTM) measurement report or the L1 measurement report as described herein, e.g. there may be provided an explicit/implicit indication etc.

It should be noted that the indication as recited herein may correspond to “at least one indication” or the indication may correspond to a single indication having multiple parts. In other words, there may be a first indication and a second indication, or there may be a single indication having at least a first part indicating a first information, and a second part indicating a second information. With respect to the above, this could mean that the indication indicates a first action, e.g. using one (first) part and indicating a second action using another (second) part, or vice versa. Additional parts of the indication may be conceivable. Alternatively, two indications may be used. “Based at least in part on the indication” may, for example, mean based on one or more part(s) of the indication. In other cases, it may mean, for example, based on the indication, e.g. as a whole, but also based on additional information and/or additional information element(s), parameters or data.

The “at least one beam” may a, in particular focused, transmission of, e.g. radio, signals, including for example, reference signals which may be transmitted using Multiple-Input Multiple-Output (MIMO) and/or beamforming techniques. Beams can have various characteristics and serve different purposes based on their configuration and use case. The at least one beam may include one or more beams or one or more beam pairs, e.g. such as a first beam and a second beam, which may be received from the same or different sources. For example, there may be a first beam from a serving cell and a second beam from a candidate or target cell. Beams may be characterized by different properties, including for example signal strength or power, which may indicate how strong a signal transmitted by the beam is at the receiver, e.g. the UE. This may be for example measured as Reference Signal Received Power (RSRP), e.g. an average received power of the reference signals, or Reference Signal Strength Indicator (RSSI), e.g. a total received power including noise and/or interference. Stronger signals may indicate better connectivity. Beams may also be characterized by signal quality, e.g. how “clean” the signal is, considering interference and/or noise. This may be for example measure as Reference Signal Received Quality (RSRQ), e.g. a ratio of RSRP to RSSI, indicating interference levels and/or Signal-to-Interference-plus-Noise Ratio (SINR), e.g. a ratio of the desired signal power to interference and/or noise power. Other properties and/or metrics are conceivable. The at least one indication may indicate for which beams the timer configuration (or one or more parts thereof) should be used, e.g. (only) for serving cell beam 1 and candidate/target cell beam 5 etc.

The indication may indicate that the at least one timer configuration (or one or more parts thereof) is/are to be applied based on initiation of early Timing Advance (TA) acquisition. For example, the at least one timer may only start (or be able to be started) when early TA acquisition is initiated. Timing Advance (TA) may refer to an adjustment, e.g. made by the User Equipment (UE), to synchronize its uplink transmission with the network node, which may provide that the signals from the UE arrive at the network node in sync with its schedule. Early TA Acquisition may refer to a scenario in which the network may initiate the TA process before a standard handover or mobility event, e.g. to prepare the UE for an upcoming switch to a target cell. This proactive approach may help reduce delay and/or potential connection loss. For example, the UE may be moving towards a cell edge where signal quality is declining. The network may initiate early TA acquisition to align uplink timing with a nearby candidate cell.

The indication may indicate that the at least one timer configuration (or one or more parts thereof) is/are to be applied on at least one of:
reception of a Target Cell Identity (TCI) state activation command, or
activation of TCI state.

A TCI state may represent a configuration of reference signals (RS) and/or beams for, in particular optimized, communication with a specific target cell. TCI State Activation Command may be regarded as a message, e.g. from the network node to the UE, instructing it to activate a specific TCI state. This may indicate which beam (or set of beams) the UE should use for communication. For example, the UE may receive a TCI state activation command to prepare for a transition to a target beam. The timer configuration may be applied, ensuring that actions like handover are handled proactively, e.g. if the beam becomes unsuitable.

The indication may indicate that the at least one timer configuration (or one or more parts thereof) is/are to be applied based on a User Equipment (UE)-TA estimate. UE-TA Estimate may refers to the UE's calculation and/or reception of an estimated TA value, which may indicate a relative distance or synchronization status between the UE and the network node. For example, a UE moving away from its serving cell may estimate an increasing TA value, signaling an impending need for a handover.

The indication may indicate that the at least one timer configuration (or one or more parts thereof) is/are to be applied based on reception of a PDCCH order for early TA acquisition. A PDCCH Order may refer to a message sent over the Physical Downlink Control Channel (PDCCH), e.g. to instruct the UE to perform a particular action, such as early TA acquisition.

It should be noted that the indication may indicate one or more of the preceding examples, e.g. a combination of one or more of the aforementioned examples is conceivable.

The apparatus, e.g. the UE, may store the at least one timer configuration, e.g. for later usage, e.g. for monitoring, identifying and/or noticing an ongoing or imminent RLF and/or for taking proactive measures, e.g. in response thereto. Determining and/or detecting that RLF is ongoing or imminent may cause, lead to, trigger and/or initiate i) starting of the at least one timer associated with and/or included in the at least one timer configuration and/or ii) transmission of a message, e.g. a measurement report, such as a Lower Layer Triggered Mobility (LTM) measurement report or a L1 measurement report to a network node. The results of i) and/or ii), e.g. that the timer has started/is running and/or that an ongoing or imminent RLF is detected may be, among others, included in the measurement report, e.g. before transmission, e.g. in the form of at least one indication, e.g. explicitly/implicitly, as described herein. To determine or detect an imminent or ongoing RLF, reference signals from a serving cell and a target cell may be measured on respective beams associated with and/or indicated by/in the at least one timer configuration. For example, the apparatus, e.g. the UE, may measure a first reference signal from a first beam of a serving cell and a second reference signal from a second beam of a target cell. The apparatus, e.g. the UE, may compare a signal strength of at least one first reference signal measured on the first beam of the serving cell with a signal strength of at least one second reference signal measured on the second beam of the target cell. Based on comparing, the apparatus may determine a result, e.g. a measurement result. For example, the apparatus, e.g. the UE, may determine that the signal strength of the at least one second reference signal on the second beam of the target cell is greater than the signal strength of the at least one first reference signal on the first beam of the serving cell. This measurement result (and/or the respective beams, e.g. the first beam and/or the second beam), among others, may be (alternatively or additionally to the above) included in the measurement report, e.g. before transmission, e.g. in the form of at least one indication, e.g. explicitly/implicitly, as described herein.

Once the at least one timer associated with and/or included in the timer configuration may, for example, expire before reception of a cell switch command from the network node. In such a case, at least one of: a re-establishment procedure or a LTM recovery procedure based on expiry of the at least one timer may be initiated. However, if the cell switch command from the network node is received before expiry of the at least one timer, at least one LTM cell switch procedure, based on the at least one cell switch command from the network node, may be initiated.

The term “non-transitory,” as used herein, is a limitation of the medium itself (i.e., tangible, not a signal) as opposed to a limitation on data storage persistency (e.g., RAM vs. ROM).

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

The apparatus may include a processor configured to provide signals to and receive signals and to control the functioning of the apparatus. The processor may be configured to control other elements of apparatus by effecting control signaling via electrical leads connecting processor to the other elements, such as a display or a memory. The processor may, for example, be embodied in a variety of ways including circuitry, at least one processing core, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits (for example, an application specific integrated circuit (ASIC), a field programmable gate array (FPGA), and/or the like), or some combination thereof.

The term “circuitry” may refer to one or more or all of the following:
(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
hardware circuit(s) and/or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The apparatus may comprise memory which may store information elements. The apparatus may include volatile memory and/or non-volatile memory. For example, volatile memory may include Random Access Memory (RAM) including dynamic and/or static RAM, on-chip or off-chip cache memory, and/or the like. Non-volatile memory, which may be embedded and/or removable, may include, for example, read-only memory, flash memory, magnetic storage devices, for example, hard disks, floppy disk drives, magnetic tape, optical disc drives and/or media, non-volatile random access memory (NVRAM), and/or the like. Like volatile memory, non-volatile memory may include a cache area for temporary storage of data. At least part of the volatile and/or non-volatile memory may be embedded in processor. The memories may store one or more software programs, instructions, pieces of information, data, and/or the like which may be used by the apparatus for performing operations disclosed herein.

The apparatus may be a UE or may be at least comprised in a UE.

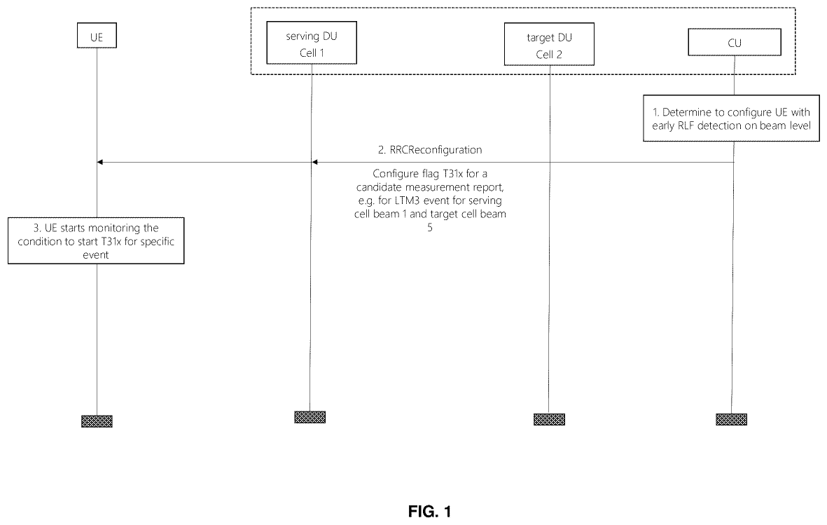

FIG. 1 shows example signaling according to subject-matter described herein, for example a signaling between a network node and an apparatus, e.g. a UE.

FIG. 1 may be explained by the following, non-limiting steps:

In step 1, the network node may determine that some cell borders for the UE can benefit from early RLF detection for the UE. The network may determine to configure the UE with early RLF detection, e.g. on beam level, e.g. with at least one timer configuration, e.g. T31x timer configuration, for monitoring an ongoing or imminent RLF. In some scenarios, the network node may for example assume that re-establishment or LTM recovery procedure after early RLF detection can recover the connection of the UE faster than, e.g. waiting for a long(er) RLF timer and, e.g., still ending up with RLF detection and/or triggering re-establishment after, e.g., staying in outage for a longer time. (For example, UE may not trigger RLF and can recover to source cell. In those examples, such an early RLF detection may be for example detrimental.) The network node may avoid such scenarios, e.g. for neighbor cells, where LTM recovery or re-establishment may not be done, such that UE may wait for full expiration of T310 (RLF detection) timer. This procedure may be configured at the same time as LTM configuration is provided to the UE or after the LTM configuration is provided to the UE.

In step 2, the network node may send at least one timer configuration for RLF detection, e.g. monitoring for an ongoing or imminent RLF to the UE. The at least one timer configuration may include at least one timer which is, e.g. indicative of a timer period for monitoring the ongoing or imminent RLF. Start, Stop, duration and/or expiry, as well as UE behavior at this timer expiry may be specified by a known or predefined standard. The at least one timer condition may include at least one condition that specifies when RLF is ongoing or imminent or when a Radio Link Problem (RLP) occurs/exists. The at least one condition may indicate that RLF is ongoing or imminent or that or the RLP occurs/exists, based on detecting a failure of at least one beam to the network node, detecting a failure recovery of at least one beam to the network node is ongoing, and/or determining that another timer is (already) running or has started. The at least one timer configuration may include at least one indication that indicates a usage requirement of the at least one timer configuration, e.g. as a whole, or of one or more parts thereof, e.g. the at least one timer, the at least one condition etc., or when these should be used/applied or are usable/applicable. In one example, the network node may indicate, e.g. using the at least one indication, that this timer configuration may be used, in particular only, for a serving cell beam 1 and candidate cell beam 5. This may indicate a specific cell border that the network determined for example as problematic. In one example, the network node may indicate, e.g. using the indication, e.g. with a flag, that this timer configuration may be considered by the UE, in particular only, if early TA acquisition is initiated, UE based TA is acquired, or UE received a candidate TCI state activation command, when TCI state is activated, and/or a combination of one or more of the preceding features.

In step 3, the UE may receive the at least one timer configuration, e.g. in/by at least one message, in particular a Lower Layer Triggered Mobility (LTM) message, e.g. a LTM configuration message, from the network node. The UE may start monitoring at least one beam from the network node based on the at least one timer configuration, e.g. based at least in part on the at least one condition that specifies when RLF is ongoing or imminent. The UE may monitor for trigger or start the at least one timer, e.g. the at least one T31x timer, e.g. based on the at least one condition.

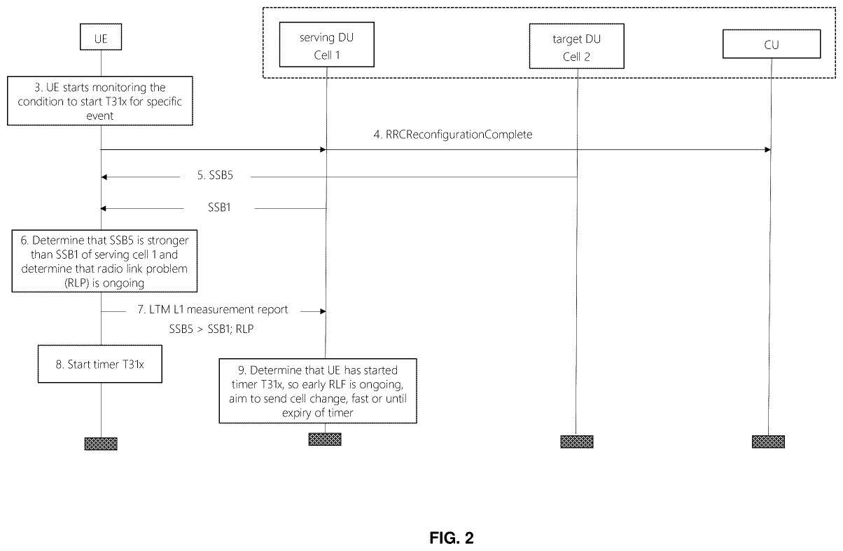

FIG. 2 shows example signaling according to subject-matter described herein, for example a signaling between a network node and an apparatus, e.g. a UE. The example shown in FIG. 2 may be combined with one or more steps shown in FIG. 1. Although steps 1-2 are not shown in FIG. 2, it should be clear that the same may simply be taken from FIG. 1.

FIG. 2 may be explained by the following, non-limiting steps:

Step 3 may correspond to Step 3 of FIG. 1 above.

In step 4, the UE may transmit or send a message, e.g. a Radio Resource Control (RRC) Reconfiguration Complete to the network node.

In step 5, the UE may start and/or continues to measure reference signals from a serving cell and a target cell on respective beams, e.g. a first reference signal, e.g. a first SSB or, for example SSB1, from a first beam, e.g. beam 1, from the serving cell (Cell 1) and a second reference signal, e.g. a second SSB or, for example SSB5, from a second beam, e.g. beam 2, from the target cell (Cell 2). The respective beams or the beam pair may be indicated by and/or associated with the at least one timer configuration, e.g. by one or more parts thereof.

In step 6, the UE may compare a signal strength of at least one first reference signal, e.g. SSB1, of the serving cell with a signal strength of at least one second reference signal, e.g. SSB5, of the target cell. The UE may determine that The UE may determine that the signal strength of the at least one second reference signal, e.g. SSB5, of the target cell is greater, or higher than the signal strength of the at least one first reference signal, e.g. SSB1, of the serving cell. The UE may determine or detect that the Radio Link Problem is ongoing or that a Radio Link Failure (RLF) is ongoing or imminent, e.g. based on the at least one condition included in the at least one timer configuration. The determination of the radio link problem may happen before step 6, at step 6-UE can re-affirm that the problem is continuing.

In step 7, the UE may transmit, e.g. based on determining that RLF is ongoing or imminent, a measurement report, such as a Lower Layer Triggered Mobility (LTM) measurement report or a L1 measurement report to a network node. The measurement report may include at least one indication that indicates that RLF is ongoing or imminent or that RLP is detected.

Step 8 may occur at the same time as step 7. In step 8, the UE may start the at least one timer, e.g. based at least in part on determining that that RLF is ongoing or imminent. In other words, the at least one timer may be started at a time of transmitting the measurement report (see step 7). The at least one indication may indicate that at least one timer has started. The measurement report may include a further indication (e.g. a second indication, in addition to the at least one, e.g. first, indication), that indicates a measurement result, e.g. SSB5>SSB1, of comparing the signal strength of the at least one second reference signal, e.g. SSB5, with the signal strength of the at least one first reference signal, e.g. SSB1. This measurement result may be indicated by or included in the further indication (e.g. the second indication) or in the at least one indication, e.g. the at least one first indication, e.g. using as described herein, different parts of the indication.

In step 9, the network may determine that the UE has started the at least one timer, e.g. timer T31x, e.g. based on and/or after receiving the measurement report, for the target cell. The network may determine also that early RLF is ongoing based on the measurement report, aiming to send a cell change, e.g. fast, or at least until or before expiry of the timer. In other words, the network node may determine that a cell switch command has to be transmitted to the UE, e.g. before the at least one timer expires.

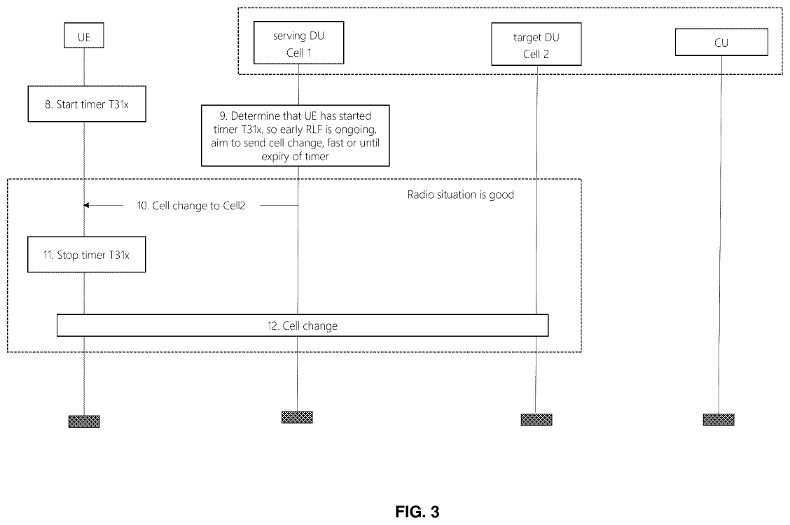

FIG. 3 shows example signaling according to subject-matter described herein, for example a signaling between a network node and an apparatus, e.g. a UE. The example shown in FIG. 3 may be combined with one or more steps shown in FIG. 1 and/or one or more steps shown in FIG. 2. Although steps 1-3 are not shown in FIG. 3, it should be clear that the same may simply be taken from FIG. 1. The same may apply for steps 4-9 from FIG. 2.

FIG. 3 may be explained by the following, non-limiting steps:

In case a radio condition allows, for example, the network node may indicate a cell change to the UE. For example, the network node may transmit to the UE a message, e.g. a cell switch command, e.g. to switch to Cell 2.

The UE may stop at least one timer, e.g. at least one timer associated with and/or included in the at least one timer configuration provided in steps 1-3 of FIG. 1 and/or started in step 8 of FIG. 2, based on reception of at least one cell switch command from the network node.

The UE may initiate at least one LTM cell switch procedure, e.g. a cell change to Cell 2, based on reception of at least one message message, wherein the at least one message may be at least one, in particular single, cell switch command from the network node. In another example, the UE may receive an indication that the radio link problem is recovered.

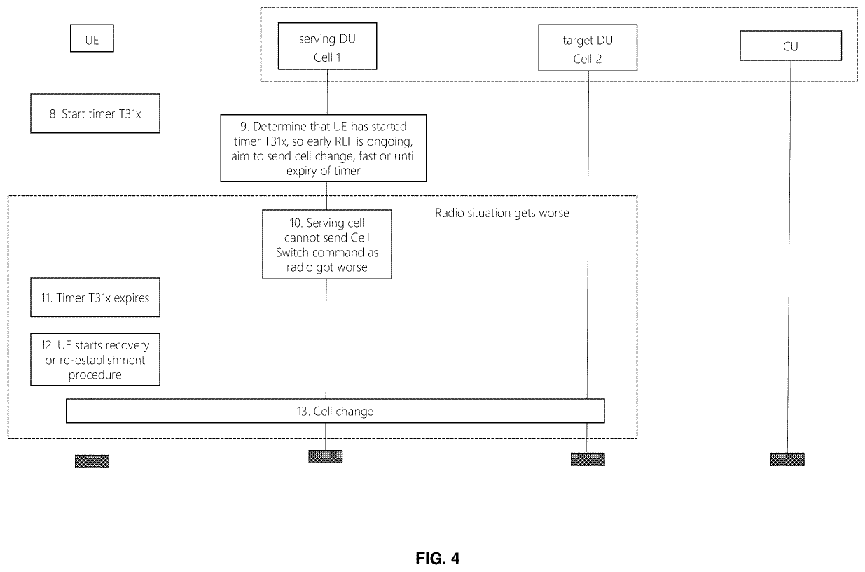

FIG. 4 shows example signaling according to subject-matter described herein, for example a signaling between a network node and an apparatus, e.g. a UE. The example shown in FIG. 4 may be combined with one or more steps shown in FIG. 1 and/or one or more steps shown in FIG. 2. Although steps 1-3 are not shown in FIG. 4, it should be clear that the same may simply be taken from FIG. 1. The same may apply for steps 4-9 from FIG. 2.

FIG. 4 may be explained by the following, non-limiting steps:

The network may not be able to send the cell switch command, e.g. due to ongoing/imminent and/or worsening RLP/RLF, e.g. bad radio conditions, so the UE may not receive the same. In another example, the UE may not receive a RLP recovery notification.

The UE may determine that the at least one timer expires, e.g. before reception of at least one cell switch command from the network node (compare with FIG. 3) and/or RLP recovery notification.

The UE may initiate at least one of: a re-establishment procedure or a LTM recovery procedure, e.g. through early RLF detection, e.g. based on expiry of the at least one timer.

The UE may change its cell as a result of recovery or re-establishment procedure, e.g., a cell change to Cell 2.

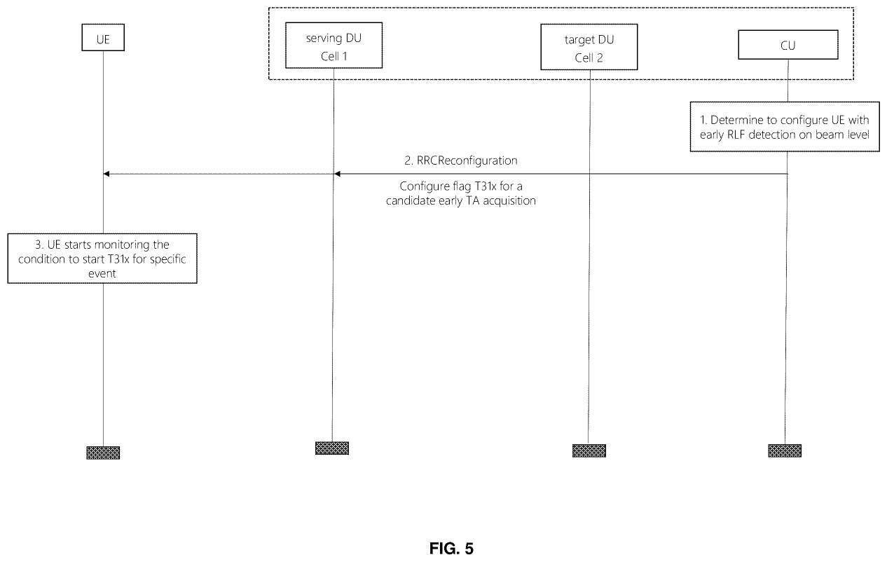

FIGS. 5-8 show examples of a signaling according to subject-matter described herein, for example a signaling between a network node and an apparatus, e.g. a UE. It should be noted that most of the steps in FIGS. 5-8 are similar/identical to the steps shown in FIGS. 1-4. For ease of reading and/or clarity, the steps described in FIGS. 1-4 are not repeated, but the same may be considered to correspondingly apply at the respective steps/stages of the procedure. In other words, the focus of the example in FIGS. 5-8 may lie on the differences of the steps as compared to the steps of FIGS. 1-4. In particular, one or more steps shown in FIGS. 1-4 may apply equally to the one or more steps shown in FIGS. 5-8.

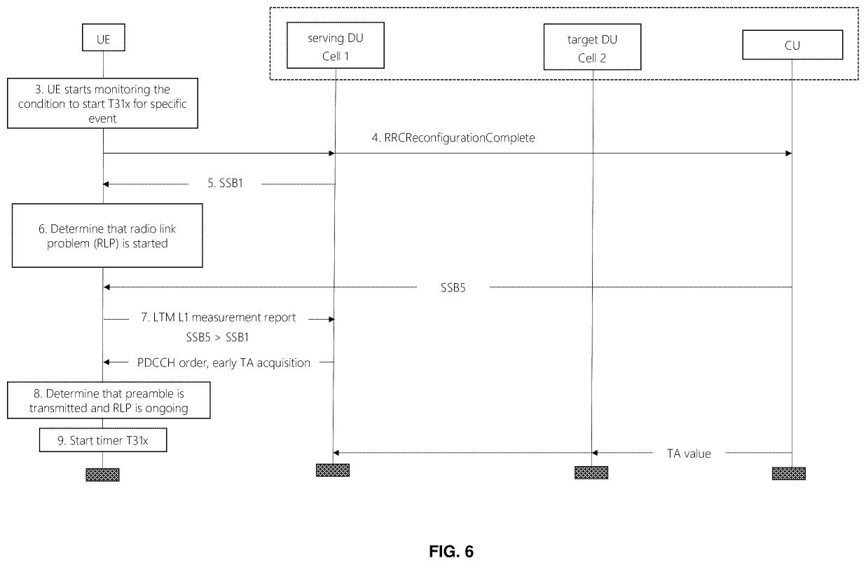

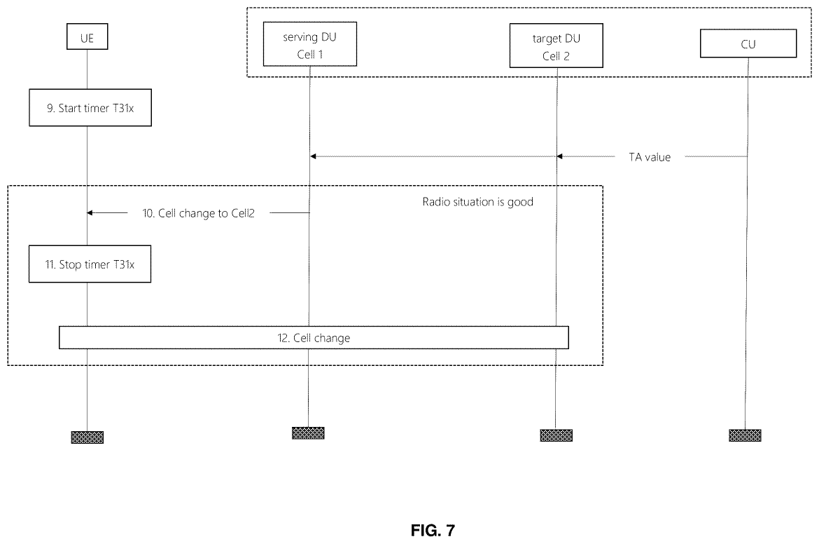

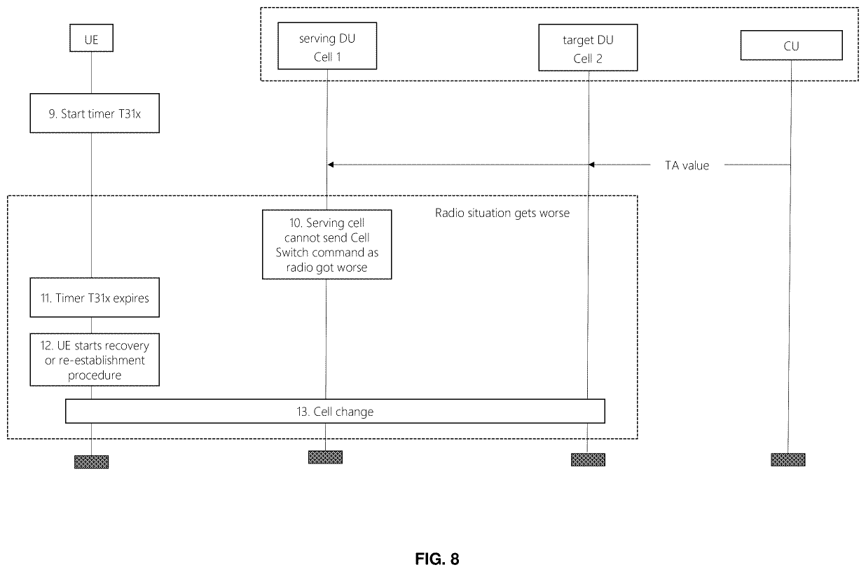

In the example shown in FIGS. 5-8, the network may be unaware, e.g. that UE has started the at least one timer, e.g. the T31x timer. The UE may start it later (s. for example FIG. 6), e.g. compared to the example shown in FIGS. 2-4. The example shown in FIGS. 5-8 may be considered a more concrete indication that the LTM cell switch command may not be received by the UE. For example, the timer may be started only after a PDCCH order is sent by the network (s. FIG. 6). The network may be supposed to send the cell switch command (in step 10, s. FIG. 7), e.g. as soon as it receives the TA value from the target DU. In case the network node does not send the cell switch command (s. FIG. 8), this might indicate a clear radio link problem RLP and/or a need for early RLF detection which will shorten the interruption time to be experienced by the UE. The example shown in FIGS. 1-4 (which may be referred to solution 1) and/or FIGS. 5-8 (which may be referred to as solution 2) can also be extended to the early TCI state activation for the UE with a similar logic (which may be referred to as solution 3). Moreover, a combination of all three of these solutions may also be thought of, e.g. to improve the precision of this procedure.

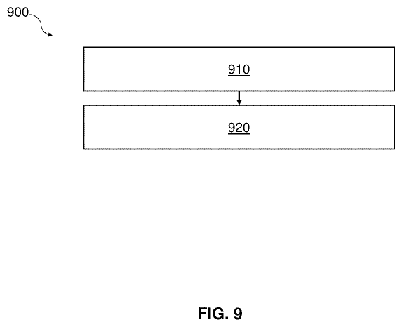

FIG. 9 shows a flow chart 900 of an example aspect of subject-matter described herein. The flow chart may comprise steps of an apparatus, a method and/or a non-transitory computer readable medium as mentioned herein.

The flow chart 900 may include the step of receiving 910 at least one Lower Layer Triggered Mobility (LTM) configuration message from a network node, which includes at least one timer configuration for monitoring of an ongoing or imminent Radio Link Failure (RLF). The flow chart 900 may include the step of monitoring 920 at least one beam from the network node based on the at least one timer configuration.

The flow chart 900 may comprise or be combined with one or more additional steps associated with some of the example aspects and/or associate example embodiments described herein.

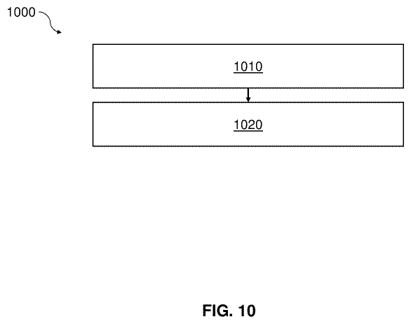

FIG. 10 shows a flow chart 1000 of an example aspect of subject-matter described herein. The flow chart may comprise steps of an apparatus, a method and/or a non-transitory computer readable medium as mentioned herein.

The flow chart 1000 may include the step of measuring 1010 reference signals from a serving cell and a target cell on respective beams associated with at least one timer configuration, wherein the timer configuration specifies when a Radio Link Failure detection (RLF) is ongoing or imminent. The flow chart 1000 may include the step of transmitting 1020, based on determining that RLF is ongoing or imminent, a measurement report to a network node which includes at least one indication that indicates that RLF is ongoing or imminent.

The flow chart 1000 may comprise or be combined with one or more additional steps associated with some of the example aspects and/or associate example embodiments described herein.

While the foregoing is directed to embodiments of the disclosure, other and further embodiments of the disclosure may be devised without departing from the basic scope thereof, and the scope thereof is determined by the claims that follow.

### LIST OF ABBREVIATIONS

LTM Lower Layer Triggered Mobility
RAT Radio Access Technology
NG Next Generation
RAN Radio Access Network
UE User equipment
TCI Transmission configuration index
RLF Radio link failure
RLP Radio link problem
BFD Beam failure detection
TA Timing advance
T31x Timer
PDCCH Physical downlink control channel
L1 Layer 1
L2 Layer 2
RRC Radio resource control
T310 Timer for RLF detection
RSRP Reference Signal Received Power
DU Distributed Unit
CU Centralized Unit
NR New Radio
DCI Downlink Control Information
PCI Physical Cell Identity
PDCCH Physical Downlink Control Channel
PDSCH Physical Data Shared Channel
UE User Equipment

### LIST OF REFERENCE NUMERALS

900-1000 Flow chart
910 Receiving step
920 Monitoring step
1010 Measuring step
1020 Transmitting step

1. An apparatus, comprising:
at least one processor; and
at least one memory storing instructions that, when executed by the at least one processor, cause the apparatus at least to perform:
receiving at least one Lower Layer Triggered Mobility (LTM) configuration message from a network node, which includes at least one timer configuration for monitoring of an ongoing or imminent Radio Link Failure (RLF),
monitoring at least one beam from the network node based on the at least one timer configuration.

2. The apparatus according to claim 1, wherein the at least one timer configuration includes at least one timer indicative of a time period for monitoring the ongoing or imminent RLF.

3. The apparatus according to claim 1, wherein the at least one timer configuration includes at least one condition that specifies when ongoing or imminent RLF is to be declared or when at least one timer associated with the at least one timer configuration is to be started.

4. The apparatus according to claim 1, wherein the at least one timer configuration includes at least one indication that indicates a usage requirement of the at least one timer configuration.

5. The apparatus according to claim 4, wherein the at least one indication indicates for which events the at least one timer configuration is to be applied.

6. The apparatus according to claim 4, wherein the at least one indication indicates at least a first beam of a target cell and at least a second beam of a serving cell for which the at least one timer configuration is to be used.

7. The apparatus according to claim 4, wherein the at least one indication indicates at least a requirement for transmission of at least one Layer 1 measurement report to the network node.

8. The apparatus according to claim 4, wherein the at least one indication indicates that the at least one timer configuration is to be applied based on at least one LTM reporting event.

9. The apparatus according to claim 8, wherein the at least one LTM reporting event is a LTM3 reporting event for which a signal strength of a beam from a target cell of the network node is compared to a signal strength of a beam from a serving cell of the network node.

10. The apparatus according to claim 8, wherein the at least one LTM reporting event is a LTM4 reporting event for which a signal strength of a beam from a target cell of the network node is compared to a predefined threshold.

11. The apparatus according to claim 4, wherein the at least one indication indicates that the at least one timer configuration is to be applied based on initiation of early Timing Advance (TA) acquisition.

12. The apparatus according to claim 4, wherein the at least one indication indicates that the at least one timer configuration is to be applied based on at least one of:
reception of a Target Cell Identity (TCI) state activation command, or
activation of TCI state.

13. The apparatus according to claim 4, wherein the at least one indication indicates that the at least one timer configuration is to be applied based on a User Equipment (UE)-TA estimate.

14. The apparatus according to claim 4, wherein the at least one indication indicates that the at least one timer configuration is to be applied based on reception of a PDCCH order for early TA acquisition.

15. The apparatus according to claim 1, wherein the at least one processor and the at least one memory storing instructions that, when executed by the at least one processor, cause the apparatus at least to perform:
detecting an ongoing or imminent RLF, and
starting at least one timer,
based at least in part on the at least on timer configuration.

16. The apparatus according to claim 1, wherein the message is a LTM Radio Resource Control (RRC) Reconfiguration message.

17. The apparatus according to claim 3, wherein the at least one condition indicates that the RLF is ongoing or imminent based on at least one of:
detecting a failure of at least one beam to the network node,
detecting that a failure recovery of at least one beam to the network node is ongoing,
determining that another timer is running, and/or
expiry of at least one timer associated with the at least one timer configuration.

18. The apparatus according to claim 1, wherein the apparatus is a User equipment (UE) or wherein the apparatus is comprised in a UE.

19. A method, comprising:
receiving at least one Lower Layer Triggered Mobility (LTM) configuration message from a network node, which includes at least one timer configuration for monitoring of an ongoing or imminent Radio Link Failure (RLF),
monitoring at least one beam from the network node based on the at least one timer configuration.

20-32. (canceled)

33. The method according to claim 19, wherein the method comprises:
detecting an ongoing or imminent RLF, and
starting at least one timer,
based at least in part on the at least on timer configuration.

34-36. (canceled)
